(19) United States
(12) Patent Application Publication
(10) Pub. No.: US 2018/0288686 A1
(43) Pub. Date: Oct. 4, 2018

(54) METHOD AND APPARATUS FOR PROVIDING INTELLIGENT MOBILE HOTSPOT

(71) Applicant: Faraday&Future Inc., Gardena, CA (US)

(72) Inventor: Xinghui Sun, San Jose, CA (US)

(21) Appl. No.: 15/662,646

(22) Filed: Jul. 28, 2017

Related U.S. Application Data
(60) Provisional application No. 62/368,943, filed on Jul. 29, 2016.

(51) Int. Cl. H04W 48/16; H04W 4/02; H04W 4/40; H04W 4/80

(52) U.S. Cl. CPC H04W 48/16; H04W 4/025; H04W 84/12; H04W 4/80; H04W 4/40

(57) ABSTRACT

A system for intelligent hotspot activation is provided. The system may include a communications interface configured for internet access associated with a vehicle. The system may activate hotspot access based on current conditions of the vehicle, and may deactivate hotspot access based on the ending of those conditions. Vehicle conditions for hotspot activation may include vehicle location, time of day, and device requests for access.

### CROSS-REFERENCE TO RELATED APPLICATIONS

This application claims the benefit of U.S. Provisional Application No. 62/368,943, filed Jul. 29, 2016, the entirety of which is hereby incorporated by reference.

### TECHNICAL FIELD

The present disclosure relates generally to methods and systems for providing an intelligent mobile-based hotspot.

### BACKGROUND

Many modern vehicles include wireless connectivity. Methods and systems presented herein provide the ability to operate a vehicle, or other mobile platform, as an intelligent hotspot.

### SUMMARY

In an embodiment, a system for intelligent hotspot activation in a vehicle is provided. The system may include a communications interface configured to be activated to establish a hotspot for network access, a memory module configured to store activation conditions, and one or more physical processors programmed by computer program instructions. When executed, the computer program instructions may cause the one or more physical processors to assess at least one current condition of the vehicle, compare the at least one current condition of the vehicle to the stored activation conditions, determine to activate hotspot access if the at least one current condition matches at least one stored activation condition; and activate the communications interface to establish the hotspot for network access.

In an embodiment, a computer implemented method for intelligent hotspot activation in a vehicle is provided. The method may be implemented on a computer system having one or more physical processors programmed with computer program instructions to perform the method. The method may comprise assessing, by the computer system, at least one current condition of the vehicle, comparing, by the computer system, the at least one current condition of the vehicle to the stored activation conditions, determining, by the computer system, to activate a communications interface to establish a hotspot for network access if the at least one current condition matches at least one stored activation condition, and activating, by the computer system, activating, by the computer system, the communications interface to establish the hotspot for network access.

In another embodiment, a vehicle comprising a communications interface including a WiFi adapter, a memory module configured to store activation conditions, and one or more physical processors programmed by computer program instructions is provided. When executed, the computer program instructions may cause the one or more physical processors to assess at least one current condition of the vehicle, compare the at least one current condition of the vehicle to the stored activation conditions, determine to convert the WiFi adapter to be a WiFi hotspot if the at least one current condition matches at least one stored activation condition, convert the WiFi adapter to be a WiFi hotspot for network access.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this disclosure, illustrate several embodiments and, together with the description, serve to explain the disclosed principles.

FIG. 1 is a graphical representation illustrating a vehicle consistent with embodiments described herein.

FIG. 2 is a schematic of an exemplary control system layout of a vehicle consistent with embodiments of the present disclosure.

FIG. 3 is a flow chart depicting steps of an exemplary method for location based hotspot provision.

FIG. 4 is a flow chart depicting steps of an exemplary method for time based hotspot provision.

FIG. 5 is a flow chart depicting steps of an exemplary method of location and time based hotspot provision.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention.

Systems, methods, and apparatuses consistent with the present disclosure may be suitable for providing hotspot access (or called access point) from a vehicle. A vehicle may be equipped with the necessary hardware to maintain a WiFi, cellular, or other type of connection to the internet, and may share that access with local devices as a hotspot or access point. Using a vehicle as a source of internet connectivity may enable a vehicle user to eliminate the need for home network based access, and may further provide a vehicle user with enhanced connectivity away from home. Devices that are part of a home-networking may be configurable to use a vehicle as a hotspot for providing internet access throughout the home. The vehicle may be configured to activate and deactivate the hotspot according to various conditions. For example, the vehicle may be configured to automatically activate as a hotspot when parked in a specific location (e.g., a garage at home) and/or at a specific time of day. Using a vehicle's internet connectivity may permit a user to maintain fewer accounts with ISPs and/or may permit a user to use less bandwidth in some accounts by accessing the internet through the vehicle hotspot rather than, for example, a mobile cellular connection.

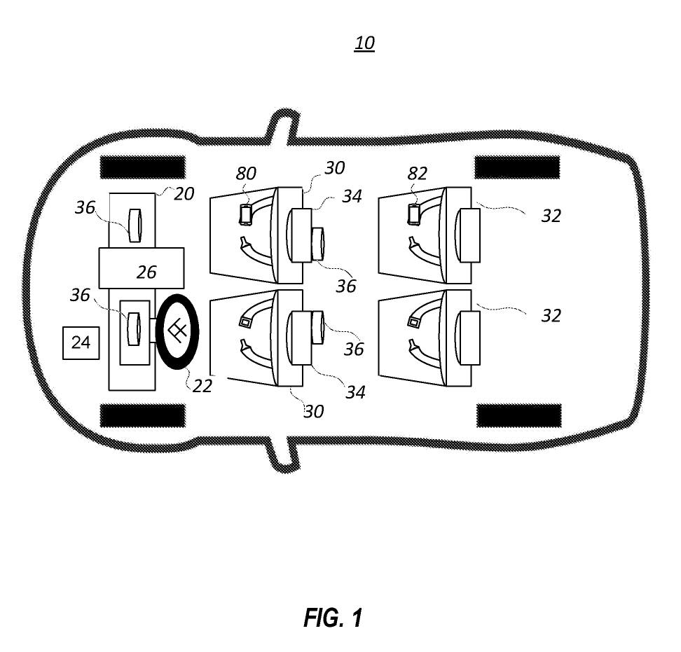

FIG. 1 is a graphical representation illustrating a vehicle 10 for detection and ranging fault detection, notification, and recovery, consistent with exemplary embodiments of the present disclosure. Vehicle 10 may have any body style of an automobile, such as a sports car, a coupe, a sedan, a pick-up truck, a station wagon, a sports utility vehicle (SUV), a minivan, or a conversion van. Vehicle 10 may also embody other types of transportation, such as motorcycles, boats, buses, trains, and planes. Vehicle 10 may be an electric vehicle, a fuel cell vehicle, a hybrid vehicle, or a conventional internal combustion engine vehicle. Vehicle 10 may be configured to be operated by a driver occupying vehicle 10, remotely controlled, and/or autonomous.

As illustrated in FIG. 1, vehicle 10 may include a number of components, some of which may be optional. Vehicle 10 may have a dashboard 20 through which a steering wheel 22 and a user interface 26 may project. In one example of an autonomous vehicle, vehicle 10 may not include steering wheel 22. Vehicle 10 may also have one or more front seats 30 and one or more back seats 32 configured to accommodate occupants. Vehicle 10 may further include one or more sensors 36 configured to detect and/or recognize occupants. The positions of the various components of vehicle 10 in FIG. 1 are merely illustrative. For example, sensor 36 may include an infrared sensor disposed on a door next to an occupant, and/or a weight sensor embedded in a seat. Vehicle 10 may also include detector and GPS unit 24 disposed at various locations, such as the front of the vehicle. The detector may include an onboard camera.

In some embodiments, user interface 26 may be configured to receive inputs from users or devices and transmit data. For example, user interface 26 may have a display including an LCD, an LED, a plasma display, or any other type of display, and provide a graphical user interface (GUI) presented on the display for user input and data display. User interface 26 may further include speakers or other voice playing devices. User interface 26 may further include input devices, such as a touchscreen, a keyboard, a mouse, and/or a tracker ball. User interface 26 may further include a housing having grooves containing the input devices. User interface 26 may be configured to provide internet access, cell phone access, and/or in-vehicle network access, such as Bluetooth™, CAN bus, or any other vehicle bus architecture protocol that may be used to access features or settings within vehicle 10. User interface 26 may be further configured to display or broadcast other media, such as maps and lane-specific route navigations.

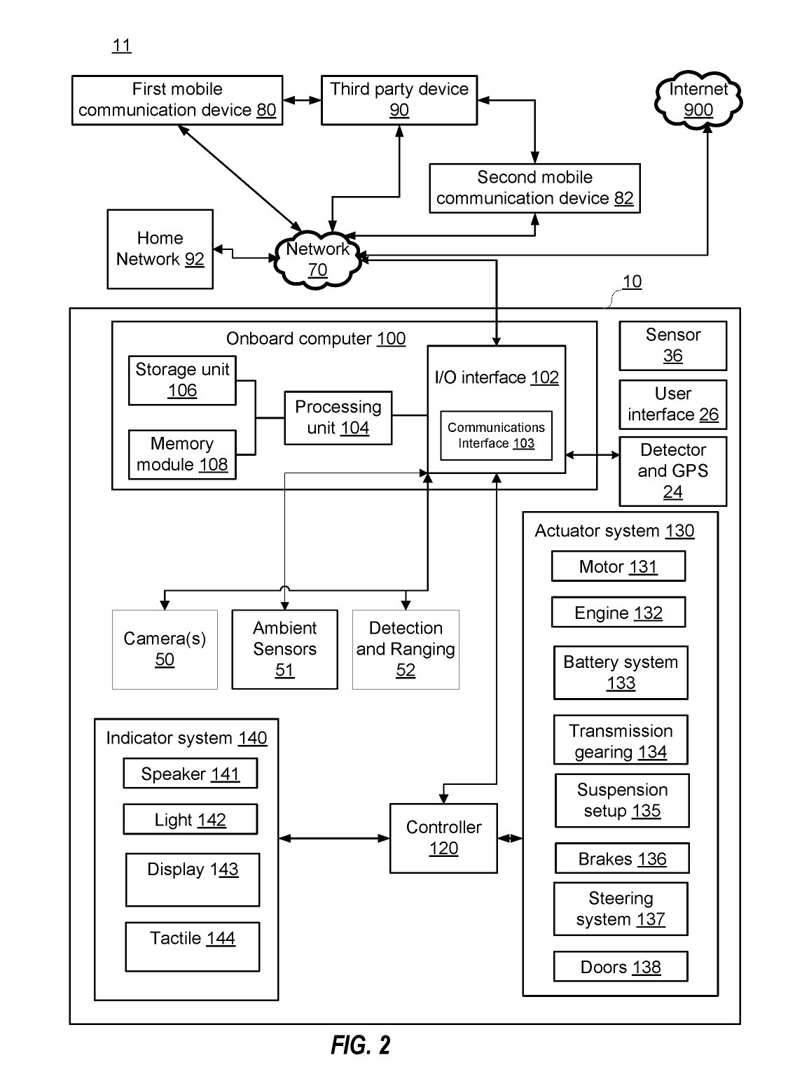

User interface 26 may also be configured to receive user-defined settings. For example, user interface 26 may be configured to receive occupant profiles including, for example, an age, a gender, a driving license status, an advanced driver assistance systems (ADAS) license status, an individual driving habit, a frequent destination, a store reward program membership, and etc. In some embodiments, user interface 26 may include a touch-sensitive surface configured to receive biometric data (e.g., detect a fingerprint of an occupant). The touch-sensitive surface may be configured to detect the ridges and furrows of a fingerprint based on a change in capacitance and generate a signal based on the detected fingerprint, which may be processed by an onboard computer described below with reference to FIG. 2. The onboard computer may be configured to compare the signal with stored data to determine whether the fingerprint matches recognized occupants. The onboard computer may also be able to connect to the Internet, obtain data from the Internet, and compare the signal with obtained data to identify the occupants. User interface 26 may be configured to include biometric data into a signal, such that the onboard computer may be configured to identify the person who is generating an input. Furthermore, user interface 26 may be configured to store data history accessed by the identified people.

Sensor 36 may include any device configured to generate a signal to be processed to detect and/or recognize occupants of vehicle 10, for example, camera, microphone sound detection sensor, infrared sensor, weight sensor, radar, ultrasonic, LIDAR, or wireless sensor for obtaining identification from occupants' cell phones. In one example, a camera 36 may be positioned on the back of a headrest 34 of a front seat 30 to capture images of an occupant in a back seat 32. In some embodiments, visually captured videos or images of the interior of vehicle 10 by camera 36 may be used in conjunction with an image recognition software, such that the software may distinguish a person from inanimate objects, and may recognize the person based on physical appearances or traits. The image recognition software may include a facial recognition software configured to match a captured occupant with stored profiles to identify the occupant. In some embodiments, more than one sensor may be used in conjunction to detect and/or recognize the occupant(s). For example, sensor 36 may include a camera and a microphone, and captured images and voices may both work as filters to identify the occupant(s) from the stored profiles.

In some embodiments, sensor 36 may include electrophysiological sensors for encephalography-based autonomous driving. For example, fixed sensor 36 may detect electrical activities of brains of the occupant(s) and convert the electrical activities to signals, such that the onboard computer can control the vehicle based on the signals. Sensor 36 may also be detachable and head-mountable, and may detect the electrical activities when worn by the occupant(s).

Detector and GPS 24 may determine in real time the location of vehicle 10 and/or information of the surrounding environment, such as street signs, lane patterns, road marks, road conditions, environment conditions, weather conditions, and traffic conditions, and send the information for processing as described below with reference to FIG. 2.

Vehicle 10 may be in communication with a plurality of mobile communication devices 80, 82. Mobile communication devices 80, 82 may include a number of different structures. For example, mobile communication devices 80, 82 may include a smart phone, a tablet, a personal computer, a wearable device, such as a smart watch or Google Glass™, and/or complimentary components. Mobile communication devices 80, 82 may be configured to connect to a network, such as a nationwide cellular network, a local wireless network (e.g., Bluetooth™ or WiFi), and/or a wired network. Mobile communication devices 80, 82 may also be configured to access apps and websites of third parties, such as iTunes™, Pandora™, Google™, Facebook™, and Yelp™.

In some embodiments, mobile communication devices 80, 82 may be carried by or associated with one or more occupants in vehicle 10. For example, vehicle 10 may be configured to determine the presence of specific people based on a digital signature or other identification information from mobile communication devices 80, 82. For instance, an onboard computer may be configured to relate the digital signature to stored profile data including the person's name and the person's relationship with vehicle 10. The digital signature of mobile communication devices 80, 82 may include a determinative emitted radio frequency (RF) or a global positioning system (GPS) tag. Mobile communication devices 80, 82 may be configured to automatically connect to or be detected by vehicle 10 through local network 70, e.g., Bluetooth™ or WiFi, when positioned within a proximity (e.g., within vehicle 10).

FIG. 2 is a block diagram illustrating a system 11 for intelligent hotspot activation consistent with exemplary embodiments of the present disclosure. System 11 may include a number of components, some of which may be optional. As illustrated in FIG. 2, system 11 may include vehicle 10, as well as other external devices connected to vehicle 10 through network 70. The external devices may include mobile terminal devices 80, 82, and third party device 90. Vehicle 10 may include a specialized onboard computer 100, a controller 120, an actuator system 130, an indicator system 140, a sensor 36, a user interface 26, a detector and GPS unit 24, one or more vehicle cameras 50, one or more ambient sensors 51, and one or more detection and ranging devices 52 (e.g., Radar and/or Lidar devices). The one or more cameras 50 may include front camera, back camera, side cameras. The ambient sensors 51 may include ambient light sensor, ambient sound sensor, etc. The detection and ranging device 52 may capture detection and ranging data, such as distances, speeds, and/or sizes of remote objects, that may be useful for various vehicle functions, including, but not limited to, steering assist, navigation, cruise control assist, and parking assist.

Onboard computer 100, actuator system 130, and indicator system 140 may all connect to controller 120. Sensor 36, user interface 26, detector and GPS unit 24, vehicle cameras 50, ambient sensors 51, and detection and ranging devices 52 may all connect to onboard computer 100. Onboard computer 100 may comprise, among other things, an I/O interface 102, a physical processing unit 104, a storage unit 106, a memory module 108. The above units of system 11 may be configured to transfer data and send or receive instructions between or among each other. Storage unit 106 and memory module 108 may be non-transitory and computer-readable and store instructions that, when executed by physical processing unit 104, cause vehicle 10 to perform the methods described in this disclosure. The onboard computer 100 may be specialized to perform the methods and steps described below.

I/O interface 102 may also be configured for two-way communication between onboard computer 100 and various components of system 11, such as user interface 26, detector and GPS 24, sensor 36, vehicle cameras 50, ambient sensors 51, and detection and ranging devices 52, as well as the external devices. I/O interface 102 may send and receive operating signals to and from mobile communication devices 80, 82, third party devices 90, and home networking equipment 92. I/O interface 102 may send and receive the data between each of the devices via communication cables, wireless networks, or other communication mediums. For example, mobile communication devices 80, 82, third party devices 90, and home networking equipment 92 may be configured to send and receive signals to I/O interface 102 via a network 70. Network 70 may be any type of wired or wireless network that may facilitate transmitting and receiving data. For example, network 70 may be a nationwide cellular network, a local wireless network (e.g., Bluetooth™ or WiFi), and/or a wired network. I/O interface 102 may include hardware necessary to carry out such communications, including, for example, cellular transmitter and/or receiver for 3G, 4G, LTE and other cellular protocols, Bluetooth transmitter and/or receiver, WiFi transmitter and/or receiver, USB, power line (data connection through power line), cable, and/or LAN connections.

Third party devices 90 may include smart phones, personal computers, laptops, pads, and/or servers of third parties (e.g., Google Maps™) that provide access to contents and/or stored data (e.g., maps, traffic, store locations, and weather). Third party devices 90 may be accessible to the users through mobile communication devices 80, 82 or directly accessible by onboard computer 100, via I/O interface 102, according to respective authorizations of the user. For example, users may allow onboard computer 100 to receive contents from third party devices by configuring settings of accounts with third party devices 90 or settings of mobile communication devices 80, 82.

Home networking equipment 92 may include various connected devices of a home network, including routers, extenders, and repeaters, laptops, desktops, servers, mobile devices, tablets, gaming systems, televisions, security systems, home automation systems, and any other devices connected through a home network.

In some embodiments, I/O interface 102 may include a communications interface 103 to provide hotspot capabilities to devices connected to it, including mobile communications devices 80, 82, third party devices 90, and home networking equipment 92. Communications interface 103 may be configured for communication with devices, networks, and other communications systems located external to vehicle 10. Communications interface 103 may send and receive operating signals to and from mobile communication devices 80, 82, third party devices 90, and home networking equipment 92. Communications interface 103 may send and receive the data between each of the devices via communication cables, wireless networks, or other communication mediums. For example, mobile communication devices 80, 82, third party devices 90, and home networking equipment 92 may be configured to send and receive signals to/from communications interface 103. Network 70 may be any type of wired or wireless network that may facilitate transmitting and receiving data. For example, network 70 may be a nationwide cellular network, a local wireless network (e.g., Bluetooth™ or WiFi), and/or a wired network. Communications interface 103 may act as a hub of network 70. Communications interface 103 may be configured to access the internet 900, via any suitable communications means.

Communications interface 103 may include hardware necessary to carry out such communications, including, for example, cellular signal transmitter and/or receiver for 3G, 4G, LTE and other cellular protocols, Bluetooth transmitter and/or receiver, WiFi transmitter and/or receiver, cable, power line (data connection through power line), and/or LAN connections. In some embodiments, communications interface 103 may include a WiFi and/or Bluetooth adapter. The adapter may be converted to be a hotspot via software configurations. Onboard computer 100 may download and execute the software to configure the adapter to be a wireless mobile hotspot. In some other embodiments, communications interface 103 may include a wireless network router, and/or a wireless repeater which is configured to connect to a router. As an example, communications interface 103 may include a WiFi router and/or a Bluetooth router. Communications interface 103 may also have cellular receiver and/or transmitter for connecting to cellular network, power line, Ethernet port and/or cable port for connecting to wired network. In such an example, communications interface 103 can function as a hub, which is connected to the internet via cellular receiver/transmitter, power line, Ethernet, or cable, and other devices can connect to the hub, and thus connect to the internet via WiFi and/or Bluetooth. Devices in vehicle or close to vehicle can also connect to the hub via wired connection.

Hotspot capabilities may permit local devices and services to connect to communications interface 103 as a hub for reconnection with the internet or remote devices and services. Communications interface 103 may provide connectivity between connected devices, with no requirement that the devices connect directly to each other. Communications interface 103 may be configured to provide a hub via WiFi, Bluetooth, LAN, USB, or any other local communications protocol. Communications interface 102 may further connect to internet 900, for example, via WiFi, LAN, USB, power line, cellular communications, or any other communications protocol. Communications interface 103 may thus permit local devices, e.g., mobile communications devices 80, 82, third party devices 90, and home networking equipment 92 using only local communications protocols, to access the internet 900 through Communications interface 103. Communications interface 103 may be configured to use any suitable local communications protocol for connecting with local devices, and may be configured to use more than one protocol simultaneously. Communications interface 103 may be configured to use any suitable communications protocol for connecting with remote devices and services, and may be configured to use more than one protocol simultaneously. Communications interface 103 may be configured to activate and deactivate hotspot access according to an assessment of one or more current conditions of the vehicle, such as a time, location, and/or whether hotspot activation has been requested.

In some embodiments, hotspot activation may occur via a physical connection between vehicle 10 and a networking device. Vehicle 10 may be plugged in to a charging unit, and the connection may include a data connection. The charging unit may include networking devices, such as a router and or WiFi access point. Thus, vehicle 10 may activate a hotspot by providing internet access to networking devices connected, in a wired or wireless fashion, to a charging unit.

In some embodiments, communications interface 103 may be caused to activate hotspot access by onboard computer 100 based on a location of vehicle 10. As discussed above, vehicle 10 may be equipped with a GPS unit, and onboard computer 100 may track the location of vehicle 10. When vehicle 10 arrives at a specific location, onboard computer 100 may automatically activate hotspot access via communications interface 103. Specific locations may include, for example, a user's garage, a user's place of work, a jobsite, and other places where a user may wish to create an internet connected network. For example, a user may desire vehicle 10 to provide hotspot access to their home whenever vehicle 10 is parked in the garage, thereby obviating a need for a home-based ISP subscription. In another example, vehicle 10 may establish a local hotspot whenever it is parked at a jobsite, such as a construction area or other location away from traditional networking infrastructure.

In some embodiments, communications interface 103 may be caused to activate hotspot access by onboard computer 100 based on time of day, day of the week, and date. A vehicle user that employs vehicle 10 for hotspot access from home may wish the hotspot access to activate and deactivate according to the user's schedule. For example, a user may schedule hotspot activation for the hours of 6 pm to 11 pm during the week, and from the hours of 7 am to 12 am on the weekends.

In some embodiments, communications interface 103 may be caused to activate hotspot access by onboard computer 100 based on both location and a time of day. Hotspot activation may be filtered by onboard computer 100 based both on location and time of day, requiring that vehicle 10 be located in a specific place at a specific time to cause hotspot activation.

In some embodiments, communications interface 103 may be caused to activate hotspot access by onboard computer 100 based on a request from a recognized network device. In some configurations, onboard computer 100 may be configured to activate hotspot access based on a request from a recognized device. A device that has been pre-cleared by a vehicle user as a recognized device may communicate with onboard computer 100 via I/O interface 102 and request access to the internet at a time and/or location when onboard computer 100 is not normally providing hotspot access. Onboard computer 100 may receive the request, and, after checking that the requesting device is on a list of approved devices stored in memory module 108, may activate hotspot access for that device until the device no longer needs it. For example, a user may wake up in the middle of the night and wish to access the internet via vehicle 10 hotspot functionality outside of the programmed access hours. A user's device may communicate with onboard computer 100 to request internet access, and onboard computer 100 may activate hotspot functionality to provide it.

In some embodiments, communications interface 103 may automatically establish connections with local networking devices when a hotspot is activated. Onboard computer 100 may keep track of devices that have used hotspot functionality in the past. When onboard computer 100 activates hotspot access, it may communicate with nearby devices that have previously used hotspot functionality, or are on a pre-approved list of devices, to establish connections with these devices. For example, a home network relying on vehicle 10 for internet access may include several to dozens of devices. Such devices may include routers, extenders, and repeaters to establish WiFi to extend WiFi access to all required areas. Such devices may further include devices such as televisions, set top boxes, security systems, as well as any other household devices that may access the internet. Furthermore, laptops, desktops, servers, gaming devices, mobile devices, and tablets may also be included in these household devices. Rather than requiring each device to specifically request access for hotspot access, which may involve significant power consumption as these devices continually request access even when vehicle 10 is not present, vehicle 10 may communicate with the household devices to notify them that hotspot access has been activated and is available. Similar notification protocols may be activated at jobsites, worksites, and other suitable locations.

Processing unit 104 may be configured to receive signals and process the signals to determine a plurality of conditions of the operation of vehicle 10, for example, through controller 120. Processing unit 104 may also be configured to generate and transmit command signals, via I/O interface 102, in order to actuate the devices in communication.

Storage unit 106 and/or memory module 108 may be configured to store one or more computer programs that may be executed by onboard computer 100 to perform functions of system 11. For example, storage unit 106 and/or memory module 108 may be configured to processing instructions to carry out the detection and ranging analysis, and fault detection methods described herein. Storage unit 106 and/or memory module 108 may further be configured to store data useful for carrying out intelligent hotspot methods described herein. For example, memory module 108 may include a database including information about hotspot activation conditions, including at least pre-approved hotspot activation locations and pre-approved hotspot activation times.

Vehicle 10 may also include a controller 120 connected to the onboard computer 100 and capable of controlling one or more aspects of vehicle operation, such as performing autonomous parking or driving operations using instructions from the onboard computer 100, and/or operating detection and ranging units.

In some examples, the controller 120 is connected to one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. Steering system 137 may include steering wheel 22 described above with reference to FIG. 1. The onboard computer 100 can control, via controller 120, one or more of these actuator systems 130 during vehicle operation; for example, to open or close one or more of the doors of the vehicle using the door actuator system 138, to control the vehicle during autonomous driving or parking operations, using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle or part of user interface 26), one or more lights 142 in the vehicle, one or more displays 143 in the vehicle (e.g., as part of a control or entertainment system in the vehicle) and one or more tactile actuators 144 in the vehicle (e.g., as part of a steering wheel or seat in the vehicle). Onboard computer 100 can control, via controller 120, one or more of these indicator systems 140 to provide indications to a driver of the vehicle of one or more characteristics of the vehicle's surroundings. The characteristics may be determined by sensor 36.

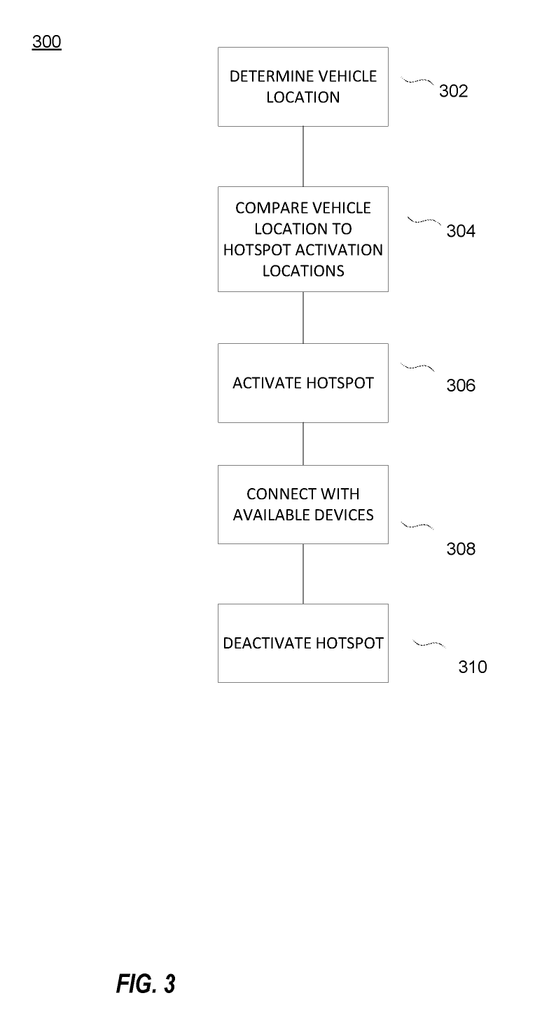

FIG. 3 is a flow chart depicting steps of an exemplary intelligent location based hotspot activation method 300. An intelligent hotspot activation method may be at least partially carried out by a processing unit 104 of onboard computer 100, which may interface with various aspects of vehicle 10 via I/O interface 102. As described with respect to FIG. 3, steps of intelligent hotspot activation method may be carried out by a processing unit 104 of onboard computer 100.

In an operation 302, onboard computer 100 may determine a vehicle location through the use of a location determining unit, such as the detector and GPS 24, cellular antenna, and/or camera 50. In some implementations, GPS location may be used to determine a vehicle location. In additional implementations, a vehicle location may be determined by cellular triangulation. Cellular triangulation may determine a vehicle location through cellular communication with one or more cellular towers. In some implementations, vehicle location may be determined based on images from cameras 50. Onboard computer 100 may compare images captured by cameras 50 with stored images to determine that a vehicle is parked in a specific location. For example, cellular and GPS location technologies may function poorly if a vehicle is parked inside a building and/or underground. A unique parking location may be identified by onboard computer 100 by comparing image data from cameras 50 with stored images associated with the unique parking location. In some implementations, a user may place an identifier, such as a bar code, QRS code, or other unique identifier, on a wall near a parking place of vehicle 10 to assist in image based location determination.

In an operation 304, onboard computer 100 may compare a determined vehicle location to stored and/or predetermined hotspot locations. Memory module 108 may be configured to store locations associated with user-designated hotspot activation locations. When vehicle 10 is parked and/or shut down, onboard computer may compare the current location to user-designated hotspot activation locations. User-designated hotspot activation locations may include locations designated by a user as appropriate for automatic hotspot access activation. If there is a match, onboard computer 100 may determine to activate hotspot access. Onboard computer 100 may compare current locations determined by any means to hotspot activation locations determined by any means.

In an operation, 306, onboard computer 100 may activate hotspot access through communications interface 103. Hotspot activation may include establishing a connection between communications interface 103 and a remote service, such as the internet, and establishing a local network, such as a WiFi, Bluetooth, or LAN network to permit connection with local devices. Hotspot activation may permit nearby devices to access the internet and/or other remote services via a connection provided by communications interface 103.

In an operation 308, onboard computer 100 may connect local available devices to the internet. Local available devices may connect through communications interface 103 to the internet or other remote service. In some implementations, local devices may autonomously establish connections. Local devices may detect the presence of the activated local network and request a connection. In some implementations, communications interface 103 may ping or otherwise notify local devices that a local network and internet access point has been established. In some implementations, the local devices notified may be known devices that have been designated by a user and/or have previously connected with vehicle 10 as a hotspot.

In an operation 310, onboard computer 100 may deactivate hotspot access. Hotspot deactivation may be based on a determination that the vehicle 10 has moved, e.g., via any of the above described means of vehicle location determination. Hotspot deactivation may be based on a determination that the vehicle 10 has been activated for driving. In some implementations, hotspot deactivation may be based on an explicit user signal.

As an example, method 300 may operate as follows. A user may drive her vehicle 10 home. As she parks vehicle 10 in her garage, vehicle 10 may compare the GPS determined location of the garaged parking space to a stored list of designated hotspot activation locations. Finding a match, onboard computer 100 may then activate hotspot access. Onboard computer 100 may proactively establish communication with the local devices. By the time the vehicle owner has entered her house from the garage, her home router, laptop, TV, and other devices may have successfully established internet access through communications interface 103.

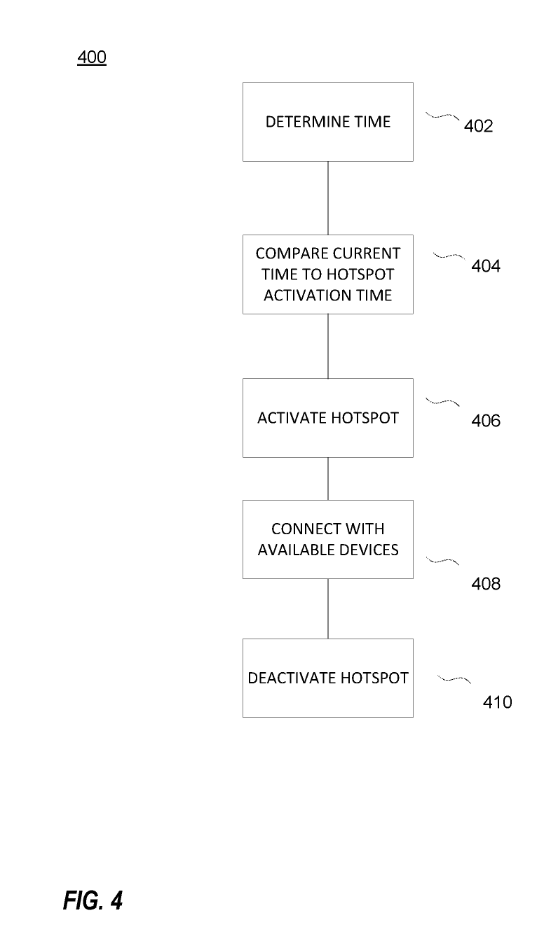

FIG. 4 is a flow chart depicting steps of an exemplary intelligent hotspot time based activation method 400. A intelligent hotspot activation method may be at least partially carried out by a processing unit 104 of onboard computer 100, which may interface with various aspects of vehicle 10 via communications interface 103. As described with respect to FIG. 4, steps of intelligent hotspot activation method may be carried out by a processing unit 104 of onboard computer 100.

In an operation 402, onboard computer 100 may determine a current time, day of the week, and or date. Onboard compute 100 may determine a current time based on an internal clock and/or based on a determined network time. In an operation 404, onboard computer 100 may compare the determined time to pre-designated times stored in memory module 108. Memory module 108 may be configured to store times, days, and dates corresponding to user-designated hotspot activation times. When vehicle 10 is parked and/or shut down, onboard computer may compare the current time to all user-designated hotspot activation times. User-designated hotspot activation times may include times designated by a user as appropriate for automatic hotspot access activation. If there is a match, onboard computer 100 may determine to activate hotspot access. In some implementations, onboard computer 100 may compare check the time to initiate hotspot activation while a vehicle is in operation.

In an operation 406, onboard computer 100 may activate hotspot access through communications interface 103. Hotspot activation may include establishing a connection between communications interface 103 and a remote service, such as the internet, and establishing a local network, such as a WiFi, Bluetooth, or LAN network to permit connection with local devices. Hotspot activation may permit nearby devices to access the internet and/or other remote services via a connection provided by communications interface 103.

In an operation 408, onboard computer 100 may connect local available devices to the internet. Local available devices may connect through communications interface 103 to the internet or other remote service. In some implementations, local devices may autonomously establish connections. Local devices may detect the presence of the activated local network and request a connection. In some implementations, communications interface 103 may ping or otherwise notify local devices that a local network and internet access point has been established. In some implementations, the local devices notified may be known devices that have been designated by a user and/or have previously connected with vehicle 10 as a hotspot.

In an operation 410, onboard computer 100 may deactivate hotspot access. Hotspot deactivation may be based on a determination that the current time is no longer within the specified hotspot activation window. Hotspot deactivation may be based on a determination that the vehicle 10 has been activated for driving. In some implementations, hotspot deactivation may be based on an explicit user signal.

As an example, method 400 may operate as follows. A user may drive her vehicle 10 home. As she parks vehicle 10, vehicle 10 may compare the current time to a stored list of designated hotspot activation times. Finding a match, onboard computer 100 may then activate hotspot access. Vehicle 10 may also wait for the scheduled time to activate hotspot. When the hotspot is activated, onboard computer 100 may proactively establish communication with the local devices. By the time the vehicle owner has entered her house from the garage, her home router, laptop, TV, and other devices may have successfully established internet access through I/O interface 102. After being active for a specific period of time, e.g., four hours, or until a specific time, e.g., 11:00 PM, onboard computer 100 may then shut down hotspot access.

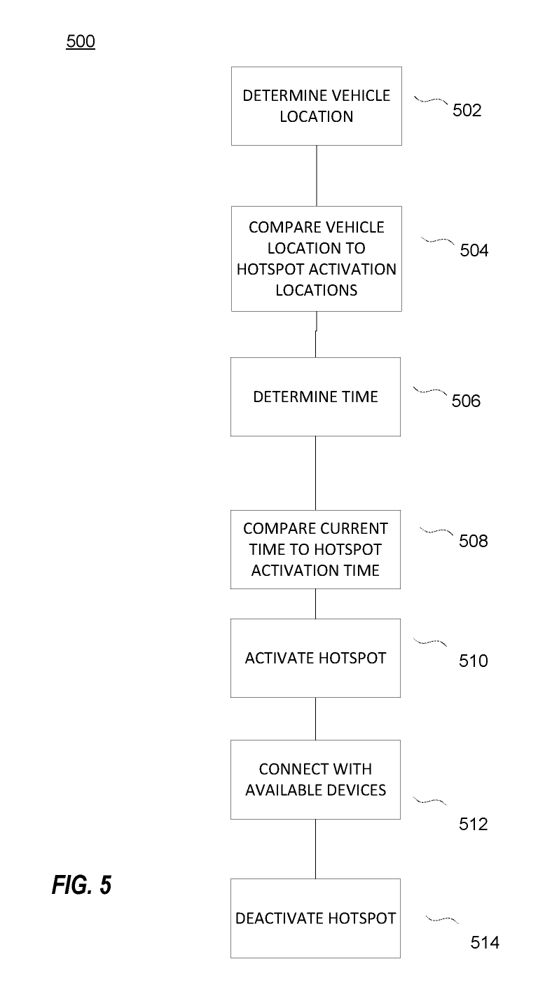

FIG. 5 is a flow chart depicting steps of an exemplary intelligent hotspot time and location based activation method 500. An intelligent hotspot activation method may be at least partially carried out by a processing unit 104 of onboard computer 100, which may interface with various aspects of vehicle 10 via I/O interface 102. As described with respect to FIG. 5, steps of intelligent hotspot activation method may be carried out by a processing unit 104 of onboard computer 100.

In an operation 502, onboard computer 100 may determine a vehicle location, as described above with respect to operation 302. In an operation 504, onboard computer 100 may compare a determined vehicle location to stored and/or predetermined hotspot locations, as discussed above with respect to operation 304. If a match is found, onboard computer may then compare the time to determine whether the current location should be activated as a hotspot.

In an operation 506, onboard computer 100 may check the time, day, and/or date, and at operation 508, compare the current time to a list of hotspot activation times associated with the determined location of vehicle 10. For example, when the vehicle 10 is parked at a user's home, a list of hotspot activation times associated with the home may be accessed to determine whether to activate the hotspot. A user may wish a hotspot to be activated only at certain times when the vehicle 10 is parked at a home, for example, 5-11 pm and 6-8 am, with the central portion of the day excluded.

In an operation 510, onboard computer 100 may activate hotspot access through I/O interface 102, as described above with respect to operation 306. In an operation 512, onboard computer 100 may connect local available devices to the internet, as previously described with respect to operation 308.

In an operation 514, onboard computer 100 may deactivate hotspot access. Hotspot deactivation may be based on a determination that the vehicle 10 has moved, e.g., via any of the above described means of vehicle location determination. Hotspot deactivation may be based on a determination that the vehicle 10 has been activated for driving. Hotspot deactivation may be based on a determination that the current time is no longer within the specified hotspot activation window. In some implementations, hotspot deactivation may be based on an explicit user signal.

As an example, method 500 may operate as follows. A user may drive her vehicle 10 home. As she parks vehicle 10 in her garage, vehicle 10 may compare the GPS determined location of the garaged parking space to a stored list of designated hotspot activation locations. Finding a match, onboard computer 100 may then determine whether the current time is within a designated hotspot activation time window. Determining that the current time, 7:15 pm, is within an activation window, onboard computer may activate hotspot access. Onboard computer 100 may proactively establish communication with the local devices. By the time the vehicle owner has entered her house from the garage, her home router, laptop, TV, and other devices may have successfully established internet access through I/O interface 102. Later, after the vehicle user has gone to sleep, onboard computer 100 may determine that the hotspot activation timing window has ended, e.g., after 11:00 pm, and deactivate the hotspot.

Methods 300, 400, and 500 describe various exemplary intelligent hotspot activation methods. The present disclosure is not limited to the exact steps of each of these methods. For example, in an alternative method, hotspot activation may be initiated based on parking at a location and deactivation may occur based on a specific time, and vice versa. In some alternative implementations, hotspot activation may be initiated based on a user request, and deactivation may occur when a vehicle has been moved to a new location. Any of the above described techniques for intelligently activating/deactivating a hotspot may be used with any other technique to appropriately suit a user's needs.

In some embodiments, a user may manually set the vehicle to activate communications interface 103 to establish a hotspot. For example, a user may drive the vehicle to camping. The user may download data, such as movies into the vehicle's memory, e.g., memory module 108 in advance. At the camping site, the user may program the onboard computer 100 to convert communications interface 103, which may include a WiFi adapter, to establish a WiFi hotspot, and the user and/or other people may connect portable computer devices to the hotspot to stream the movies from the vehicle's computer system. The vehicle may also have a cellular network connection. The user and/or other people may connect portable computer devices to the hotspot and thus connect to the internet via the cellular network.

Another aspect of the disclosure is directed to a non-transitory computer-readable storage medium storing instructions which, when executed, cause one or more processors to perform methods, as discussed above. The computer-readable storage medium may include volatile or non-volatile, magnetic, semiconductor, tape, optical, removable, non-removable, or other types of computer-readable storage medium or computer-readable storage devices. For example, the computer-readable storage medium may be the storage unit or the memory module having the computer instructions stored thereon, as disclosed. In some embodiments, the computer-readable storage medium may be a disc or a flash drive having the computer instructions stored thereon.

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for detection and ranging device fault detection, notification, and recovery. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A system for intelligent hotspot activation in a vehicle, the system comprising:
a communications interface configured to be activated to establish a hotspot for network access;
a memory module configured to store activation conditions;
one or more physical processors programmed by computer program instructions that, when executed, cause the one or more physical processors to:
assess at least one current condition of the vehicle;
compare the at least one current condition of the vehicle to the stored activation conditions;
determine to activate the communication interface to establish a hotspot if the at least one current condition matches at least one stored activation condition; and
activate the communications interface to establish the hotspot for network access.

2. The system of claim 1, further comprising a location determining unit,
wherein to assess the at least one current condition of the vehicle, the one or more physical processors are caused to activate the location determining unit to determine a current location of the vehicle; and
wherein to compare the at least one current condition of the vehicle to the stored activation conditions, the one or more physical processors are caused to compare the current location of the vehicle to designated hotspot activation locations stored in the memory module.

3. The system of claim 2, wherein the location determining unit includes a GPS unit, and wherein the one or more physical processors are caused to determine the current location of the vehicle based on GPS information provided by the location determining unit.

4. The system of claim 2, wherein the location determining unit includes a camera, and wherein the one or more physical processors are caused to determine the current location of the vehicle based on image data provided by the location determining unit.

5. The system of claim 2, wherein the one or more physical processors are further caused to:
determine that the vehicle has left a designated hotspot activation location; and
deactivate the communications interface as a hotspot according to the determination that the vehicle has left the designated hotspot activation location.

6. The system of claim 2, wherein the one or more physical processors are further caused to:
determine a current time;
compare the current time to designated hotspot activation times stored in the memory module; and
deactivate the communications interface as a hotspot according to a determination that the current time is not a designated hotspot activation time.

7. The system of claim 1, wherein to assess the at least one current condition of the vehicle, the one or more physical processors are caused to determine a current time; and
wherein to compare the at least one current condition of the vehicle to the stored activation conditions, the one or more physical processors are caused to compare the current time to designated hotspot activation times stored in the memory module.

8. The system of claim 7, wherein the one or more physical processors are further caused to:
determine a second current time;
compare the second current time to designated hotspot activation times stored in the memory module; and
deactivate the communications interface as a hotspot according to a determination that the second current time is not a designated hotspot activation time.

9. The system of claim 1, wherein to assess the at least one current condition of the vehicle, the one or more physical processors are caused to receive a device request; and
wherein to compare the at least one current condition of the vehicle to the stored activation conditions, the one or more physical processors are caused to compare the device request to pre-approved devices stored in the memory module.

10. The system of claim 1, wherein the one or more physical processors are further caused to:
access a database of local devices stored in the memory module associated with the stored activation condition matching the current condition; and
send a request to at least one of the local devices associated with the stored activation condition to initiate a connection.

11. A computer implemented method for intelligent hotspot activation in a vehicle, the method being implemented on a computer system having one or more physical processors programmed with computer program instructions to perform the method, the method comprising:
assessing, by the computer system, at least one current condition of the vehicle;
comparing, by the computer system, the at least one current condition of the vehicle to the stored activation conditions;
determining, by the computer system, to activate a communications interface to establish a hotspot for network access if the at least one current condition matches at least one stored activation condition; and
activating, by the computer system, the communications interface to establish the hotspot for network access.

12. The method of claim 11,
wherein assessing the at least one current condition of the vehicle includes activating a location determining unit to determine a current location of the vehicle; and
comparing the at least one current condition of the vehicle to the stored activation conditions includes comparing the current location of the vehicle to designated hotspot activation locations stored in the memory module.

13. The method of claim 12, wherein the location determining unit includes a camera, and wherein determining the current location of the vehicle is based on image data provided by the location determining unit.

14. The method of claim 12, further comprising
determining, by the computer system, that the vehicle has left a current hotspot activation location; and
deactivating, by the computer system, the communications interface as a hotspot according to the determination that the vehicle has left the current hotspot activation location.

15. The method of claim 12, further comprising:
determining, by the computer system, a current time;
comparing, by the computer system, the current time to designated hotspot activation times stored in the memory module; and
deactivating, by the computer system, the communications interface as a hotspot according to a determination that the current time is not a designated hotspot activation time.

16. The method of claim 11, wherein assessing the at least one current condition of the vehicle includes determining a current time; and
comparing the at least one current condition of the vehicle to the stored activation conditions includes comparing a current time to designated hotspot activation times stored in the memory module.

17. The method of claim 16, further comprising
determining, by the computer system, a second current time; and
comparing, by the computer system, the second current time to designated hotspot activation times stored in the memory module; and
deactivating, by the computer system, the communications interface as a hotspot according to a determination that the second current time is not a designated hotspot activation time.

18. The method of claim 11, wherein assessing the at least one current condition of the vehicle includes receiving a device request; and
wherein comparing the at least one current condition of the vehicle to the stored activation conditions includes comparing the device request to pre-approved devices stored in the memory module.

19. The method of claim 11, further comprising:
accessing, by the computer system, a database of local devices stored in the memory module associated with the stored activation condition matching the current condition; and
sending, by the computer system, a request to at least one of the local devices associated with the stored activation condition to initiate a connection.

20. A vehicle comprising:
a communications interface including a WiFi adapter;
a memory module configured to store activation conditions;
one or more physical processors programmed by computer program instructions that, when executed, cause the one or more physical processors to:
assess at least one current condition of the vehicle;
compare the at least one current condition of the vehicle to the stored activation conditions;
determine to convert the WiFi adapter to be a WiFi hotspot if the at least one current condition matches at least one stored activation condition; and
convert the WiFi adapter to be a WiFi hotspot for network access.
